(19) United States
(12) Patent Application Publication
(10) Pub. No.: US 2021/0387829 A1
(43) Pub. Date: Dec. 16, 2021

(54) ELEVATOR SCHEDULING METHODS, APPARATUSES, SERVERS AND COMPUTER READABLE STORAGE MEDIA

(71) Applicant: Rajax Network Technology (Shanghai) Co., Ltd., Shanghai (CN)

(72) Inventors: Wei MIN, Shanghai (CN); Pei LI, Shanghai (CN); Huitao HAO, Shanghai (CN); Jinzhong ZHANG, Shanghai (CN); Binbin CHEN, Shanghai (CN)

(21) Appl. No.: 17/286,182

(22) PCT Filed: Mar. 26, 2019
(86) PCT No.: PCT/CN2019/079728

§ 371 Date: Apr. 16, 2021

(30) Foreign Application Priority Data
Oct. 17, 2018 (CN) 201811208541.8

(51) Int. Cl. B66B 1/34; B66B 1/24; B66B 1/46; H04W 4/80

(52) U.S. Cl. CPC B66B 1/3461; B66B 1/2408; B66B 1/468; H04W 4/80; B66B 2201/104; B66B 2201/4676; B66B 2201/215; B66B 2201/4615; B66B 2201/4638; B66B 2201/4653; B66B 2201/212

(57) ABSTRACT

An elevator scheduling method and an apparatus, a server, and a computer-readable storage medium are provided. The elevator scheduling method is applied to a server, and comprises: determining an elevator schedule request, wherein the elevator schedule request comprises starting floor information and target floor information; determining a target elevator to be scheduled to a target robot based on the elevator schedule request and operation information of schedulable elevators; generating a control instruction based on the starting floor information, the target floor information, and identification information of the target elevator; and sending the control instruction to an elevator control device, wherein the elevator control device controls movement of the target elevator.

### CROSS REFERENCE TO RELATED APPLICATIONS

The present disclosure claims priority to Chinese Patent Application No. 201811208541.8, entitled “ELEVATOR SCHEDULING METHOD, DEVICE, SERVER AND COMPUTER READABLE STORAGE MEDIUM”, filed Oct. 17, 2018, the entire contents of which are incorporated herein by reference.

### TECHNICAL FIELD

Embodiments of the present disclosure relate to the technical field of telecommunication, and more particularly, to methods for scheduling an elevator, devices for scheduling an elevator, servers and computer readable storage media.

### BACKGROUND

With continuous development of artificial intelligence and robotics technology, intelligent vehicles and robots have been widely used in various industries. In particular, commercial service robots and delivery robots with automatic positioning and navigation functions that have emerged in recent years may realize autonomous delivery of goods in specific places such as office buildings and hotel buildings, which may greatly reduce labor intensity in related industries, improve production efficiency of these industries, and reduce labor costs in industries such as hotels, express delivery, and food delivery. In office buildings or hotel buildings, commercial service robots and delivery robots need to take elevators to deliver goods between floors. In order to solve this problem, robots or smart vehicles need to be able to automatically enter, exit and take the elevators in the building.

However, applicant has found that the related technology has at least the following problem: when there are a plurality of elevators in an office building or a hotel building, the elevators may not be properly scheduled.

It should be noted that the information disclosed in the background section is only used to facilitate understanding of the background of the application, and therefore may include information that does not constitute the prior art known to those of ordinary skill in the art.

### SUMMARY

An objective of part in the embodiments of the present disclosure is to provide methods for scheduling an elevator, apparatuses for scheduling an elevator, servers and computer readable storage media.

Embodiments of the present disclosure provide a method for scheduling elevators, applied to a server, including: determining an elevator schedule request, the elevator schedule request including starting floor information and target floor information; determining a target elevator to be scheduled to a target robot based on the elevator schedule request and operation information of schedulable elevators; generating a control instruction based on the starting floor information, the target floor information, and identification information of the target elevator; and sending the control instruction to an elevator control device, wherein the elevator control device controls movement of the target elevator.

Embodiments of the present disclosure also provide an apparatus for scheduling elevators, including: a determining module, a scheduling module, a generating module, and a communication module, wherein the determining module is configured to determine an elevator schedule request, wherein the elevator schedule request includes starting floor information and target floor information; the scheduling module is configured to determine a target elevator to be scheduled to a target robot based on the elevator schedule request and operation information of schedulable elevators; the generating module is configured to generate a control instruction based on the starting floor information, the target floor information, and identification information of the target elevator; and the communication module is configured to send the control instruction to an elevator control device, wherein the elevator control device controls movement of the target elevator.

Embodiments of the present disclosure also provide a server including: at least one processor; and a memory communicatively connected with the at least one processor ; and a communication component receiving and sending data under the control of the processor, wherein the communication component is communicatively connected with an elevator control device; wherein the memory stores instructions executable by the at least one processor, and the instructions are executed by the at least one processor to implement: determining an elevator schedule request, wherein the elevator schedule request includes starting floor information and target floor information; determining a target elevator to be scheduled to a target robot based on the elevator schedule request and operation information of schedulable elevators; generating a control instruction based on the starting floor information, the target floor information, and identification information of the target elevator; and sending the control instruction to an elevator control device, wherein the elevator control device controls movement of the target elevator.

Embodiments of the present disclosure also provide a computer-readable storage medium storing a computer program that, when executed by a processor, implements the method for scheduling an elevator described in the above embodiments.

For example, before sending the control instruction to the elevator control device, the method for scheduling the elevator further includes: receiving an elevator call request sent by the target robot, wherein the elevator call request includes authorization information, and the authorization information is information fed back to the target robot by the elevator control device in response to receiving an authorization request sent by the target robot; and determining that the authorization information in the elevator call request is correct.

For example, the target robot communicates with the elevator control device via a near field communication technology.

For example, the elevator schedule request is sent by the target robot upon determining that an elevator is to be taken by itself.

For example, after determining the target elevator to be scheduled to the target robot based on the elevator schedule request and the operation information of schedulable elevators, the method includes: sending identification information of the target elevator the target robot, wherein the identification information of the target elevator is used to identify the target elevator.

For example, before determining the target elevator to be scheduled to the target robot based on the elevator schedule request and the operation information of schedulable elevators, the method further includes: determining the target robot for delivering goods based on robot information, wherein the robot information includes state information of a robot and/or information of a floor where the robot is currently located; and sending a delivery instruction to the target robot.

For example, determining the target robot based on the robot information includes: determining the target robot based on the robot information and order information of the goods; before sending the delivery instruction to the target robot, the method further includes: generating the delivery instruction based on the order information of the goods.

For example, the elevator schedule request further includes authentication information of the target robot; after determining the elevator schedule request, and before determining the target elevator to be scheduled to the target robot based on the elevator schedule request and the operation information of schedulable elevator, the method further includes: verifying the authentication information, and determining that the authentication information is successful verified.

For example, after sending the control instruction to the elevator control device, the method further includes: after determining that the target elevator reaches a floor corresponding to the starting floor information, sending an elevator entry instruction to the target robot, wherein the elevator entry instruction is used to instruct the target robot to enter the target elevator; after determining that the target elevator reaches a floor corresponding to the target floor information, sending an elevator exit instruction to the target robot, wherein the elevator exit instruction is used to instruct the target robot to leave the target elevator.

For example, the operation information of schedulable elevators includes state information of schedulable elevators, and the state information of a schedulable elevator is used to indicate this schedulable elevator is in a scheduled state or an unscheduled state; determining a target elevator to be scheduled to the target robot based on the elevator schedule request and the operation information of schedulable elevator includes: based on the state information of respective elevators, selecting one elevator from elevators in the unscheduled state as the target elevator.

For example, the operation information of a schedulable elevator includes a moving direction of this schedulable elevator and current floor information of this schedulable elevator; determining the target elevator to be scheduled to the target robot based on the elevator schedule request and the operation information of schedulable elevators includes: determining a moving direction of the target robot based on the starting floor information and the target floor information; based on the operation information of schedulable elevators, taking one or more elevators having a moving direction which is the same as the moving direction of the target robot as candidate schedule elevators; and based on the current floor information of each of the candidate schedule elevators and the starting floor information, selecting one elevator from the candidate schedule elevators as the target elevator.

For example, the operation information of a schedulable elevator includes an occupancy rate of this schedulable elevator; determining the target elevator to be scheduled to the target robot based on the elevator schedule request and the operation information of schedulable elevators includes: based on the occupancy rate of schedulable elevators, selecting a schedulable elevator of which the occupancy rate is the lowest as the target elevator.

For example, the operation information of a schedulable elevator includes stopping floors information of this schedulable elevator; determining a target elevator to be scheduled to the target robot based on the elevator schedule request and the operation information of schedulable elevators includes: based on the stopping floors information of schedulable elevators and the elevator schedule request, determining whether there is a schedulable elevator of which stopping floors include a floor corresponding to the starting floor information and/or a floor corresponding to the target floor information; and in response to determining that there is such a schedulable elevator of which stopping floors include the floor corresponding to the starting floor information or the floor corresponding to the target floor information, taking this schedulable elevator as the target elevator.

For example, the operation information of a schedulable elevator includes a number of stopping floors of this schedulable elevator; determining a target elevator to be scheduled to the target robot based on the elevator schedule request and the operation information of schedulable elevators includes: based on the number of stopping floors of schedulable elevators, selecting a schedulable elevator of which the number of stopping floors is the smallest as the target elevator.

For example, the processor is further configured to: before sending the control instruction to the elevator control device, receive an elevator call request sent by the target robot, wherein the elevator call request includes authorization information, and the authorization information is information fed back to the target robot by the elevator control device in response to receiving an authorization request sent by the target robot; and determine that the authorization information in the elevator call request is correct.

For example, the target robot communicates with the elevator control device via a near field communication technology.

For example, the elevator schedule request is sent by the target robot upon determining that an elevator is to be taken by itself.

For example, the processor is further configured to: after determining the target elevator to be scheduled to the target robot based on the elevator schedule request and the operation information of schedulable elevators, send identification information of the target elevator the target robot, wherein the identification information of the target elevator is used to identify the target elevator.

For example, the processor is further configured to: before determining the target elevator to be scheduled to the target robot based on the elevator schedule request and the operation information of schedulable elevators, determine the target robot for delivering goods based on robot information, wherein the robot information includes state information of a robot and/or information of a floor where the robot is currently located; and send a delivery instruction to the target robot.

For example, the processor is further configured to: determine the target robot based on the robot information and the order information of the goods; before sending the delivery instruction to the target robot, the processor is further configured to generate the delivery instruction based on order information of the goods.

For example, the elevator schedule request further includes authentication information of the target robot; the processor is further configured to: after determining the elevator schedule request, and before determining the target elevator to be scheduled to the target robot based on the elevator schedule request and the operation information of schedulable elevators, verify the authentication information, and determine that the authentication information is successful verified.

For example, the processor is further configured to: after sending the control instruction to the elevator control device, and after determining that the target elevator reaches a floor corresponding to the starting floor information, send an elevator entry instruction to the target robot, wherein the elevator entry instruction is used to instruct the target robot to enter the target elevator; after determining that the target elevator reaches a floor corresponding to the target floor information, send an elevator exit instruction to the target robot, wherein the elevator exit instruction is used to instruct the target robot to leave the target elevator.

For example, the operation information of schedulable elevators includes state information of schedulable elevators, and the state information of a schedulable elevator is used to indicate this schedulable elevator is in a scheduled state or an unscheduled state; the processor is configured to: based on the state information of respective elevators, select one elevator from elevators in the unscheduled state as the target elevator.

For example, the operation information of a schedulable elevator includes a moving direction of this schedulable elevator and current floor information of this schedulable elevator; the processor is configured to: determine a moving direction of the target robot based on the starting floor information and the target floor information; based on the operation information of schedulable elevators, take one or more elevators having a moving direction which is the same as the moving direction of the target robot as candidate schedule elevators; and based on the current floor information of each of the candidate schedule elevators and the starting floor information, select one elevator from the candidate schedule elevators as the target elevator.

For example, the operation information of a schedulable elevator includes an occupancy rate of this schedulable elevator; the processor is configured to: based on the occupancy rate of schedulable elevators, select a schedulable elevator of which the occupancy rate is the lowest as the target elevator.

For example, the operation information of a schedulable elevator includes stopping floors information of this schedulable elevator; the processor is configured to: based on the stopping floors information of schedulable elevators and the elevator schedule request, determine whether there is a schedulable elevator of which stopping floors include a floor corresponding to the starting floor information and/or a floor corresponding to the target floor information; and in response to determining that there is such a schedulable elevator of which stopping floors include the floor corresponding to the starting floor information or the floor corresponding to the target floor information, take this schedulable elevator as the target elevator.

For example, the operation information of a schedulable elevator includes a number of stopping floors of this schedulable elevator; the processor is configured to: based on the number of stopping floors of schedulable elevators, select a schedulable elevator of which the number of stopping floors is the smallest as the target elevator.

### BRIEF DESCRIPTION OF DRAWINGS

One or more embodiments are illustrated by pictures in corresponding drawings, and these illustrated descriptions do not constitute a limitation on the embodiments.

FIG. 1 is a flowchart of a method for scheduling an elevator according to a first embodiment of the present disclosure;

FIG. 2 is a flowchart of a method for scheduling an elevator according to a second embodiment of the present disclosure;

FIG. 3 is a schematic diagram of connection among a robot, a device for controlling an elevator, and a server according to the second embodiment of the present disclosure;

FIG. 4 is a block diagram of an apparatus for scheduling an elevator according to a third embodiment of the present disclosure;

FIG. 5 is a block diagram of a server according to a fourth embodiment of the present disclosure.

### DETAILED DESCRIPTION

In order to make objectives, technical solutions, and advantages of the present disclosure clearer, some embodiments of the present disclosure are described in further detail below with reference to the accompanying drawings and embodiments. It should be understood that the specific embodiments described here are only used to explain the present disclosure and are not intended to limit the present disclosure.

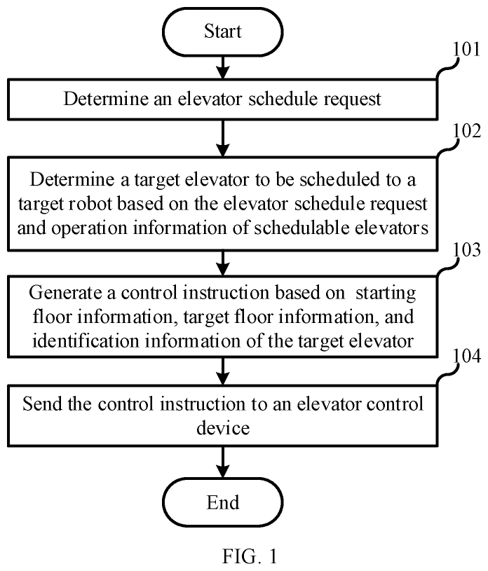

The first embodiment of the present disclosure relates to a method for scheduling an elevator, which is applied to a server. As shown in FIG. 1, the method for scheduling the elevator includes the following steps.

At step 101, an elevator schedule request is determined.

Specifically, the elevator schedule request includes starting floor information and target floor information. The elevator schedule request may be determined by a delivery management system in the server, or the elevator schedule request may be sent to the server directly by a target robot upon determining that an elevator is to be taken by itself.

It should be noted that those skilled in the art may understand that in practical applications, the delivery management system may be located on other server which establishes a connection with the server for communication purpose, so that the server may receive the elevator schedule request determined by the delivery management system.

It should be noted that goods may be objects such as takeout, commodities, flowers, documents, etc., and the present embodiment does not limit specific delivery objects.

In a first implementation, the elevator schedule request is determined by the delivery management system in the server.

In an example, the server determines that there are goods, in a first storage container where a robot picks up the goods, that need to be delivered, and generates a delivery instruction. Based on robot information, the server determines a target robot to deliver the goods, and sends the delivery instruction to the target robot. The server determines information of a floor where the target robot is located, takes the information of the floor where the target robot is located as the starting floor information, and takes information of a floor where the first storage container is located as the target floor information, and determines the elevator schedule request based on the starting floor information and the target floor information.

In another example, the server determines that a courier needs a robot to assist in delivering goods. The server determines a target robot for delivering the goods based on the robot information, generates a delivery instruction based on order information of the goods, and sends the delivery instruction to the target robot. The server determines the information of the floor where the target robot is located, takes the information of the floor where the target robot is located as the starting floor information, and takes information of a floor where the courier is located as the target floor information, and determines the elevator schedule request based on the starting floor information and the target floor information.

It is worth mentioning that the server may schedule an elevator immediately after the delivery is desired, so that the target robot may take the elevator in time after picking up the goods, which may improve the delivery efficiency.

It should be noted that the robot information includes state information of a robot and/or information of a floor where the robot is currently located. The state information of the robot may be information indicating whether the robot is in an available-for-delivery state or information about a current number of orders in a cabin of the robot. Those skilled in the art may understand that in practical applications, the state information of robot may be information related to goods delivery of the robot, which will not be repeated herein.

The method for the server to determine a target robot for delivering the goods based on robot information includes but not limited to the following four approaches.

Approach 1: the server arbitrarily selects a robot from robots in the available-for-delivery state as the target robot for delivering goods based on the state information of the robot.

Approach 2: the server selects a robot closest to the floor where the first storage container is located or the floor where the courier is located as the target robot for delivering goods based on the information of the floor where the robot is currently located.

Approach 3: the server arbitrarily selects several robots as candidate robots from the robots in the available-for-delivery state based on the state information of robot. The server selects a robot that is closest to the floor where the first storage container is located or the floor where the courier is located from the candidate robots as the target robot for delivering goods based on the information of the floors where the candidate robots are currently located.

Approach 4: the server arbitrarily selects several robots as candidate robots from the robots in the available-for-delivery state based on the state information of robot. The server selects a robot from the candidate robots as the target robot for delivering goods based on the order information of the goods, for example, the weight information of the goods.

It should be noted that the order information of goods may include a delivery address, a goods attribute (should be heated or refrigerated for use or used at room temperature), weight and other information; the robot information may further include other information such as carrying weight information of robot, and information whether the robot has a function of heating or refrigerating goods. Those skilled in the art may understand that in practical applications, the server may fully consider one or any combination of the above types of information to determine the target robot. For example, when the goods attribute indicate that the goods should be heated for use, the server selects a robot from robots that have the function of heating the goods as the target robot.

It should be noted that those skilled in the art may understand that in practical applications, the state information of robot may further include other information such as a quantity of goods in the robot cabin. The server may determine the target robot for delivering the goods after considering overall the state information of robot, the information of the floor where the robot is currently located, and other information. The present disclosure does not limit the specific method for the server to determine the target robot for delivering the goods.

In a second implementation, the elevator schedule request is sent by the target robot after determining that an elevator is to be taken by itself.

In an example, after a robot picks up goods at a first storage container, the robot is determined as the target robot. The target robot determines starting floor information and target floor information, and decides whether the starting floor information is the same as the target floor information. If it is determined that the starting floor information is different from the target floor information, the target robot generates an elevator schedule request based on the starting floor information and the target floor information, and sends the elevator schedule request to the server. The server receives and determines the elevator schedule request. The starting floor information is information of the floor where the target robot is located, and the target floor information may be determined based on the delivery address of the goods, or may be determined based on information of a floor where the second storage container for a user to pick up the goods is located.

In another example, a courier places goods directly in a cabin of a robot, and then the robot is determined as the target robot. The target robot determines starting floor information and target floor information, and decides whether the starting floor information is the same as the target floor information. If it is determined that the starting floor information is different from the target floor information, the target robot generates an elevator schedule request based on the starting floor information and the target floor information, and sends the elevator schedule request to the server. The server receives and determines the elevator schedule request. The starting floor information is information of the floor where the target robot is located. The target floor information may be determined based on the order information of the goods, or may be determined based on the information input by the courier through an operation interface of the target robot, or may be determined based on the floor where the second storage container for a user to pick up the goods is located.

It should be noted that those skilled in the art may understand that in practical applications, the elevator schedule request may further include other information such as weight of the delivery object (such as goods), which will not be repeated herein, but may be set as desired in practical applications.

At step 102, an elevator to be scheduled to the target robot is determined based on the elevator schedule request and operation information of schedulable elevators.

Specifically, the operation information of an elevator may include any one or more of: state information of this elevator, identification information of this elevator, current floor information of this elevator, state information of this elevator door, and a moving direction of this elevator, which is not listed one by one herein. The state information of this elevator is used to indicate this elevator is in a scheduled state or an unscheduled state. The operation information of schedulable elevators in the server may be provided by an elevator control device. One server may communicate with a plurality of elevator control devices in one building, or may communicate with a plurality of elevator control devices in a plurality of buildings.

Hereinafter, the method for the server to determine the target elevator scheduled to the target robot based on the elevator schedule request and the operation information of schedulable elevators will be described with reference to an example.

In a first example, the operation information of a schedulable elevator includes a moving direction of this schedulable elevator and current floor information of this schedulable elevators. The server determines a moving direction of the target robot based on the starting floor information and the target floor information in the elevator schedule request. Based on the operation information of schedulable elevators, the server takes one or more the elevators having a moving direction which is the same as the moving direction of the target robot as candidate schedule elevators, and selects an elevator from the candidate schedule elevators as the target elevator based on the current floor information of each of the candidate schedule elevators and the starting floor information. For example, the server may select an elevator closest to the floor corresponding to the starting floor information as the target elevator based on the current floor information of each of the candidate schedule elevators and the starting floor information.

In a second example, the operation information of schedulable elevators includes the state information of schedulable elevators, and the state information of a schedulable elevator is used to indicate this schedulable elevator is in a scheduled state or an unscheduled state. The server selects an elevator as the target elevator from elevators in the unscheduled state based on the state information of schedulable elevators.

In a third example, the operation information of a schedulable elevator includes an occupancy rate of this schedulable elevator. Based on the occupancy rate of the schedulable elevator, the server selects a schedulable elevator of which the occupancy rate is the lowest as the target elevator.

In a fourth example, the operation information of a schedulable elevator includes stopping floors information of this schedulable elevator. The server determines whether there is a schedulable elevator of which stopping floors include a floor corresponding to the starting floor information or a floor corresponding to the target floor information, based on the stopping floors information of schedulable elevators and the elevator schedule request; and if it is determined there is such a schedulable elevator of which stopping floors include the floor corresponding to the starting floor information or the floor corresponding to the target floor information, takes this schedulable elevator as the target elevator.

In a fifth example, the operation information of a schedulable elevator includes a number of stopping floors of this schedulable elevator. The server selects a schedulable elevator of which the number of stopping floors is the smallest as the target elevator based on the number of stopping floors of schedulable elevators.

In a sixth example, the operation information of schedulable elevators includes any two or more of the information mentioned in the above examples. For example, the operation information of a schedulable elevators includes a moving direction of this schedulable elevators, current floor information of this schedulable elevator, and the state information of this schedulable elevator. The server determines the candidate schedule elevators based on the moving direction of schedulable elevators. Based on the current floor information of schedulable elevators and the state information of schedulable elevators, the server preferentially selects an elevator that is closest to the current floor where the target robot is located and is in an unscheduled state as the target elevator. If there is no elevator that meets the above requirements, the elevator closest to the floor where the target robot is currently located is selected as the target elevator.

It should be noted that those skilled in the art may understand that in practical applications, a specific logic for determining the target elevator may be set for the server as desired, and this embodiment does not limit the specific logic of the server for determining the target elevator.

It is worth mentioning that the server performs elevator scheduling, and the server may update the operation information of elevators and the robot information in time, so as to better schedule the elevator and the robot.

At step 103, a control instruction is generated based on the starting floor information, the target floor information, and identification information of the target elevator.

At step 104, the control instruction is sent to the elevator control device.

Specifically, the elevator control device controls the movement of the target elevator so that the target elevator moves to the floor corresponding to the starting floor information, and after determining that the target robot has boarded on the target elevator, controls the target elevator to move to the floor corresponding to the target floor information.

In an example, the elevator control device controls the movement of the target elevator after receiving the control instruction. After determining that the target elevator reaches the floor corresponding to the starting floor information, the server sends an elevator entry instruction to the target robot; where the elevator entry instruction is used to instruct the target robot to enter the target elevator. After determining that the target elevator reaches the floor corresponding to the target floor information, an elevator exit instruction is sent to the target robot; where the elevator exit instruction is used to instruct the target robot to leave the target elevator.

In an example, after the target robot enters the target elevator or leaves the target elevator, the target robot sends a completion instruction to the server, so that the server knows a relative state between the target robot and the target elevator, so as to facilitate scheduling the elevator.

It should be noted that, in this embodiment, for clarity of description, step 104 is provided as a subsequent step of step 103. However, those skilled in the art may understand that in practical applications, step 104 may be provided as after step 102, and step 104 may be provided as any step after step 102 as desired, which is not limited in this embodiment.

It should be noted that the above described are only examples and do not limit the technical solutions of the present disclosure.

Compared with the related art, in the method for scheduling the elevator provided in this embodiment, the server obtains the starting floor information and target floor information of the robot, and combines the operation information of schedulable elevators to schedule the elevator for the robot so that the robot may take the elevator automatically when there are a plurality of elevators. Since the server schedules elevators for all robots, the server may obtain the information of all robots, so that when scheduling the elevator for the robot, the server may fully consider the information of all robots and schedule the elevator for the robot, realizing collaborative operation of a plurality of robots in a same building in an efficient manner.

The second embodiment of the present disclosure relates to a method for scheduling an elevator. This embodiment is further improved based on the first embodiment, specifically by adding other related steps before step 102 and step 104 respectively.

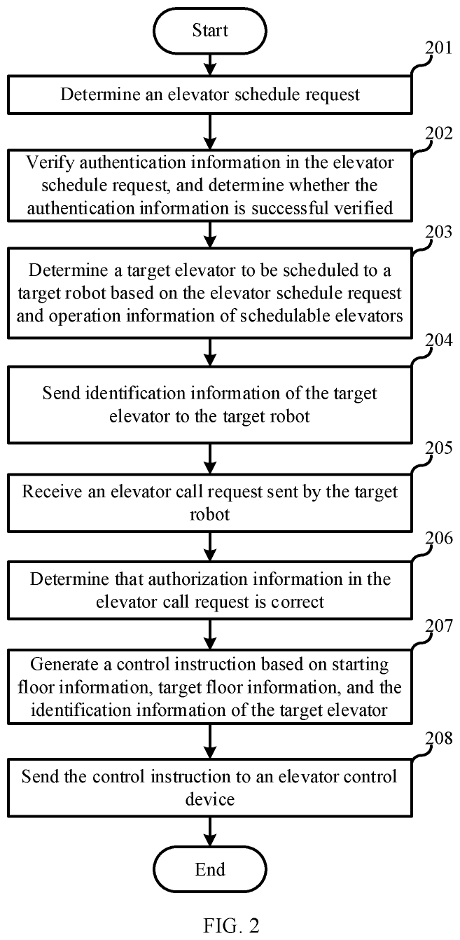

Specifically, as shown in FIG. 2, in this embodiment, the method includes steps 201 to 207, where step 201, step 203, step 207, and step 208 are respectively similar as steps 101 to 104 in the first embodiment, which will not be repeated here. The differences are mainly introduced below.

Step 201 is performed.

At step 202, authentication information in the elevator schedule request is verified, and it is determined that the authentication information is successful verified.

Specifically, the elevator schedule request further includes authentication information of the delivery management system or authentication information of the target robot. The server verifies the authentication information, and has confirmed that a device sending the elevator schedule request is a registered or authorized device.

It is worth mentioning that the server verifies the device sending the schedule request to prevent external devices or unsecured devices from accessing the server, which may improve the security of the server and prevent devices failing to meet requirements from occupying resources of the server.

Step 203 is performed.

At step 204, identification information of the target elevator is sent to the target robot.

Specifically, the identification information of the target elevator, for example, the serial number of the target elevator, is used to identify the target elevator.

It should be noted that the identification information of the target elevator may indicate the location of the target elevator. For example, after the target robot receives the serial number of the target elevator, the target robot may query the location of the elevator corresponding to the serial number. Alternatively, the identification information of the target elevator may be determined by location information of the target elevator, and the target robot may obtain location of the target elevator by analyzing the identification information of the target elevator.

It is worth mentioning that since the identification information of the target elevator may indicate the location of the target elevator, when a plurality of elevators in the building, where the target robot is located, are located at different locations, the target robot may move to the target elevator based on the identification information of the target elevator.

At step 205, an elevator call request sent by the target robot is received.

Specifically, the elevator call request includes authorization information, and the authorization information is information that the elevator control device feeds back to the target robot after receiving an authorization request sent by the target robot. After receiving the identification information of the target elevator returned by the server, the target robot sends the authorization information request to the elevator control device corresponding to the identification information of the target elevator. The elevator control device corresponding to the identification information of the target elevator sends the authorization information to the target robot after receiving the authorization information request.

It is worth mentioning that after the target robot obtains the authorization information of the elevator control device, the server sends a control instruction to the elevator control device, which may improve the security.

In an example, the target robot communicates with the elevator control device via a near field communication technology, such as LoRa technology.

It is worth mentioning that since the target robot communicates with the elevator control device by the near field communication technology, the target robot may obtain the authorization information sent by the elevator control device only when the target robot is within a certain distance of the elevator control device, and it may avoid wasting resources caused by scheduling the elevator to the floor where the target robot is located too early.

It should be noted that those skilled in the art may understand that, in actual applications, conditions for the elevator control device to return authorization information may be set as desired, and this embodiment does not limit the specific authorization method.

At step 206, it is determined that the authorization information in the elevator call request is correct.

Specifically, after determining that the elevator call request is received, the server decides whether the authorization information in the elevator call request is correct. If it is determined that the authorization information in the elevator call request is correct, steps 207 and 208 are performed, otherwise, no elevator is scheduled to the target robot.

It is worth mentioning that after the server obtains the authorization information of the elevator control device thorough the target robot, the server sends a control instruction to make the elevator control device control the movement of elevator, which may further improve the security of the scheduling process.

Step 207 and step 208 are performed.

It should be noted that step 202, step 205, and step 206 are not mandatory steps. Step 202, step 205, and step 206 may be selectively performed, or only step 202 is performed, or only step 205 and step 206 are performed.

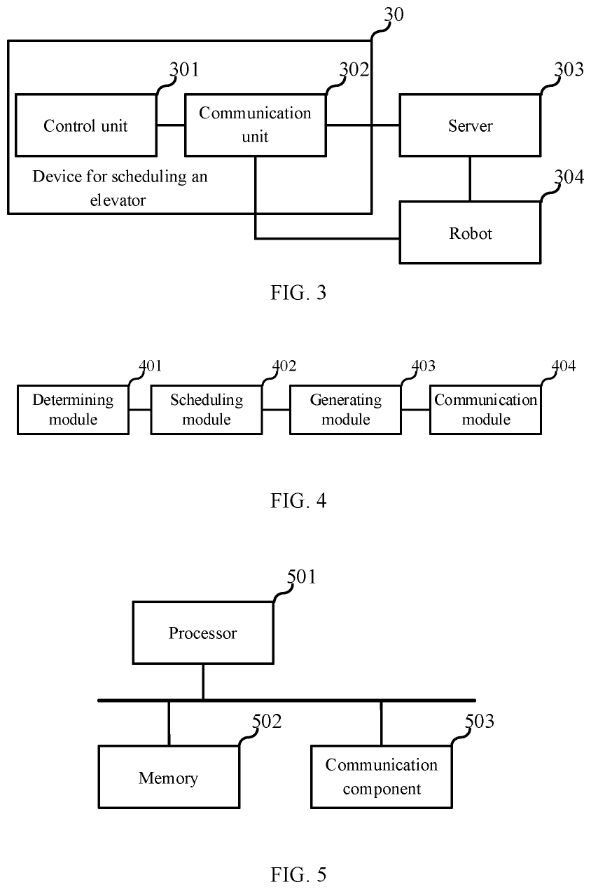

Hereinafter, an example will be provided to illustrate a process of interaction among the robot, the elevator control device, and the server to complete the elevator taking task. A connection relationship among the robot, the elevator control device and the server is shown in FIG. 3. The elevator control device 30 includes a control unit 301 and a communication unit 302. In an example, the communication unit 302 may be deployed on the top of each elevator car, and communicate with the control unit 301 of each elevator based on a communication protocol negotiated with the elevator manufacturer. The communication unit 302 is equipped with a remote communication module such as 4G. The 4G module may communicate with the server 303 based on the Constrained Application Protocol (CoAP). The data format is JavaScript Object Notation (json), and the underlying communication protocol is the User Datagram Protocol (UDP). The communication unit 302 is further provided with a near field communication module to communicate with the robot 304. The robot 304 is equipped with a remote communication module such as 4G, which may communicate with the server 303, and is further equipped with a near field communication module to communicate with the communication unit 302. The server 303 is provided with an elevator back-end management system, including an elevator back-end and an elevator management platform. The elevator back-end is a bridge for the elevator management platform to communicate with the communication unit 302 and the robot 304. Both the elevator management platform and the robot 304 will send requests to the elevator back-end. The elevator back-end may have functions such as elevator registration, robot registration, elevator login, robot login, elevator heartbeat report, robot heartbeat report, and forwarding elevator schedule requests and elevator call requests to elevator management platform, and so on. The elevator operation information is stored in the elevator management platform, and is updated in real time based on the operation information of elevators fed back by the elevator control device, and the elevator management platform may schedule an elevator for the robot based on the elevator schedule request, the elevator call request, etc.

When the robot 304 performs an elevator taking task near an elevator, the robot 304 first sends an elevator schedule request to the server 303. After receiving the elevator schedule request, the server 303 determines a target elevator based on the elevator schedule request and operation information of schedulable elevators. That is, the server 303 determines which elevator to be scheduled to complete the task based on a preset elevator schedule algorithm. The server sends identification information of the communication unit 302 in the target elevator to the robot 304. After the robot 304 receives the identification information of the communication unit 302 returned by the server 303, the robot 304 sends an authorization information request to the communication unit 302 corresponding to the identification information via near field communication. After the communication unit 302 receives the authorization information request, the communication unit 302 sends the authorization information to the robot 304. After the robot 304 obtains the authorization information returned by the communication unit 302, the robot 304 includes the authorization information in the elevator call request and sends the authorization information together with the elevator call request to the server 303. The server 303 decides whether the authorization information is correct. If the authorization information is correct, the server 303 sends a control instruction to the communication unit 302. After receiving the control instruction, the communication unit 302 sends the control instruction to the control unit 301. The control unit 301 controls the movement of the target elevator to complete the elevator call action. After receiving the control instruction, the control unit 301 controls the target elevator to move to the floor corresponding to the starting floor information. At this time, the operation information of the target elevator indicates that the target elevator has reached the floor corresponding to the starting floor information. After the server 303 determines that the target elevator has reached the floor corresponding to the starting floor information based on the operation information of the target elevator, the server 303 sends an elevator entry instruction to the robot 304. The robot 304 enters the target elevator after receiving the elevator entry instruction, and after entering the target elevator, the robot 304 sends an elevator entry completion instruction to the server 303. After the server 303 receives the elevator entry completion instruction, the server 303 sends the elevator entry completion instruction to the communication unit 302, and the communication unit 302 transmits the elevator entry completion instruction to the control unit 301. The control unit 301 controls the target elevator to move to the floor corresponding to the target floor information. At this time, the operation information of the target elevator indicates that the target elevator has reached the floor corresponding to the target floor information. The server 303 determines that the target elevator has reached the floor corresponding to the target floor information based on the operation information of the target elevator, and then sends an elevator exit instruction to the robot 304. The robot 304 leaves the target elevator after receiving the elevator exit instruction, and after leaving the target elevator, the robot 304 sends the elevator exit completion instruction to the server 303.

It is worth mentioning that during the entire process of performing the elevator taking task, the robot 304 may indirectly communicate with the communication unit 302, for example, indirectly communicate with the communication unit 302 via the server 303 to complete the task of automatically taking the elevator, and thus avoiding malicious control by the robot 304.

It is worth mentioning that by reconstructing the embedded code on the communication unit 302, control protocol in various brands of elevators may be parsed to realize compatibility with the control systems in various brands of elevators.

It should be noted that the above described are only examples and do not limit the technical solutions of the present disclosure.

Compared with the prior art, in the method for scheduling the elevator provided in this embodiment, the server obtains the starting floor information and target floor information of the robot, and combines the operation information of schedulable elevators to schedule an elevator for the robot, making it possible for the robot to take the elevator automatically when there are a plurality of elevators. Since the server schedules elevators for all robots, the server may obtain information of all robots, so that when scheduling an elevator for a robot, the server may fully consider the information of all robots and schedule the elevator for the robot, thus realizing collaborative operation of a plurality of robots in the same building in an efficient manner. In addition, the server schedules the elevator after successfully verifying the authentication information in the elevator schedule request, so as to prevent external devices or unsecure devices from accessing the server, and prevent devices failing to meet requirements from occupying resources of the server. Further, after the server receives an elevator call request and determines that the authorization information in the elevator call request is correct, the server sends a control instruction to the elevator control device to make the elevator control device control the movement of the elevator, which may further improve the security of the scheduling process.

The division of the steps in various methods above is just for clarity of description. When implemented, some steps may be combined into one step, or may be split into multiple steps, as long as they include the same logical relationship, which are all in the scope of protection of the present disclosure. Adding insignificant modifications to the algorithm or process or introducing insignificant designs without changing the core design of the algorithm and process are all within the scope of protection of the present disclosure.

The third embodiment of the present disclosure relates to an apparatus for scheduling an elevator, as shown in FIG. 4, including: a determining module 401, a scheduling module 402, a generating module 403, and a communication module 404. The determining module 401 is configured to determine an elevator schedule request, wherein the elevator schedule request includes starting floor information and target floor information. The scheduling module 402 is configured to determine a target elevator to be scheduled to a target robot based on the elevator schedule request and operation information of schedulable elevators. The generating module 403 is configured to generate a control instruction based on the starting floor information, the target floor information and identification information of the target elevator. The communication module 404 is configured to send the control instruction to the elevator control device, wherein the elevator control device controls the movement of the target elevator.

Apparently, this embodiment is an apparatus embodiment corresponding to the first embodiment and the second embodiment, and this embodiment may be implemented in cooperation with the first embodiment and the second embodiment. The related technical details mentioned in the first embodiment and the second embodiment are still applied in this embodiment, and in order to reduce repetition, details will not be repeated here. Correspondingly, the related technical details mentioned in this embodiment may also be applied to the first embodiment and the second embodiment.

It is worth mentioning that the modules involved in the third embodiment are all logical modules. In practical applications, a logical unit may be a physical unit, or a part of a physical unit, or may be implemented as a combination of multiple physical units. In addition, in order to highlight the innovative part of the application, the third embodiment does not introduce units that are not too closely related to solving the technical problems proposed by the present disclosure, but this does not indicate that there are no other units in the third embodiment.

A fourth embodiment of the present disclosure relates to a server, as shown in FIG. 5, including: at least one processor 501; and a memory 502 communicatively connected with the at least one processor 501; and a communication component 503 receiving and sending data under the control of the processor, wherein the communication component 503 communicatively connected with an elevator control device, wherein the memory 502 stores instructions that may be executed by the at least one processor 501, and the instructions are executed by the at least one processor 501 to implement: determining an elevator schedule request, where the elevator schedule request includes starting floor information and target floor information; determining an elevator to be scheduled to a target robot based on the elevator schedule request and operation information of schedulable elevators; generating a control instruction based on the starting floor information, the target floor information and identification information of the target elevator, wherein the elevator control device controls the movement of the target elevator.

The server includes: one or more processors 501 and a memory 502. In FIG. 5, for example, there is one processor 501. The processor 501 and the memory 502 may be connected via a bus or in other ways. In FIG. 5, the connection through a bus is taken as an example. The memory 502, as a non-volatile computer-readable storage medium, may be configured to store non-volatile software programs, non-volatile computer-executable programs, and modules. The processor 501 executes various functional applications and data processing of devices by running the non-volatile software programs, instructions, and modules stored in the memory 502, thereby realizing the above-mention method for scheduling the elevator.

The memory 502 may include a storage program area and a storage data area. The storage program area may store an operating system and an application program required by at least one function; the storage data area may store a list of options and the like. In addition, the memory 502 may include a high-speed random access memory, or may include a non-volatile memory, such as at least one magnetic disk storage device, a flash memory device, or other non-volatile solid-state storage devices. In some embodiments, the memory 502 may optionally include a memory remotely provided with respect to the processor 501, and the remote memory may be connected with an external device through a network. Examples of the aforementioned networks include, but are not limited to, the Internet, corporate intranets, local area networks, mobile communication networks, and combinations thereof.

One or more modules are stored in the memory 502, and when executed by the one or more processors 501, the method for scheduling the elevator in any of the foregoing method embodiments is executed.

A fifth embodiment of the present disclosure relates to a server. This embodiment is a further refinement of the fourth embodiment, and specifically describes the function of the processor 501.

Specifically, the processor 501 is further configured to: before sending a control instruction to the elevator control device, receive an elevator call request sent by the target robot, wherein the elevator call request includes authorization information, and the authorization information is information fed back to the target robot by the elevator control device in response to receiving an authorization request sent by the target robot; and determine that the authorization information in the elevator call request is correct.

In addition, the target robot communicates with the elevator control device via a near field communication technology.

In addition, the elevator schedule request is sent by the target robot after determining that an elevator is to be taken by itself.

In addition, the processor is further configured to: after determining the target elevator to be scheduled to the target robot based on the elevator schedule request and the operation information of schedulable elevators, send identification information of the target elevator to the target robot, wherein the identification information of the target elevator is used to identify the target elevator.

In addition, the processor is further configured to: before determining the target elevator to be scheduled to the target robot based on the elevator schedule request and the operation information of schedulable elevators, and before sending the identification information of the target elevator to the target robot, based on robot information, determine a target robot to deliver the goods; the robot information includes state information of a robot and/or information of a floor where the robot is currently located; and send a delivery instruction to the target robot.

In addition, the processor is further configured to: determine the target robot based on the robot information and order information of the goods; before sending the delivery instruction to the target robot, the processor is further configured to: generate the delivery instruction based on the order information of the goods.

In addition, the elevator schedule request further includes authentication information of the target robot; the processor is further configured to: after determining the elevator schedule request, and before determining the target elevator to be scheduled to the target robot based on the elevator schedule request and the operation information of schedulable elevators, verify the authentication information, and determine that the authentication information is successful verified.

In addition, the processor is further configured to: after sending the control instruction to the elevator control device, after determining that the target elevator has reached a floor corresponding to the starting floor information, send an elevator entry instruction to the target robot, wherein the elevator entry instruction is used to instruct the target robot to enter the target elevator; after determining that the target elevator has reached a floor corresponding to the target floor information, send an elevator exit instruction to the target robot, wherein the elevator exit instruction is used to instruct the target robot to leave the target elevator.

In addition, the operation information of a schedulable elevator includes state information of a schedulable elevator, and the state information of this schedulable elevator is used to indicate that this schedulable elevator is in a scheduled state or an unscheduled state. The processor is configured to: based on the state information of respective schedulable elevators, select one elevator as the target elevator from elevators in the unscheduled state.

In addition, the operation information of a schedulable elevator includes a moving direction of this schedulable elevator and current floor information of this schedulable elevators. The processor is configured to determine a moving direction of the target robot based on the starting floor information and the target floor information; based on the operation information of schedulable elevators, take one or more elevators having a moving direction which is the same as the moving direction of the target robot as candidate schedule elevators; and based on the current floor information of each of the candidate schedule elevators and the starting floor information, select one elevator from the candidate schedule elevators as the target elevator.

In addition, the operation information of a schedulable elevator includes an occupancy rate of this schedulable elevator. The processor is configured to select a schedulable elevator of which the occupancy rate is the lowest as the target elevator based on the occupancy rate of schedulable elevators.

In addition, the operation information of a schedulable elevators includes stopping floors information of this schedulable elevators. The processor is configured to determine whether there is an elevator of which stopping floors include a floor corresponding to the starting floor information or a floor corresponding to the target floor information from the schedulable elevators, based on the stopping floors information of schedulable elevators and the elevator schedule request; and in response to determining that there is such an elevator of which stopping floors include the floor corresponding to the starting floor information or the floor corresponding to the target floor information, take the elevator as the target elevator.

The above-mentioned products may execute the methods provided in the embodiments of the present disclosure, and have corresponding functional modules and beneficial effects for executing the methods. The technical details are not described in detail in this embodiment, reference may be made to the methods provided in the embodiments of the present disclosure.

A sixth embodiment of the present disclosure relates to a computer-readable storage medium, which stores a computer program. When the computer program is executed by the processor, the above method embodiment is realized.

That is, those skilled in the art may understand that all or part of the steps in the method of the above-mentioned embodiments may be implemented by instructing relevant hardware through a program. The program is stored in a storage medium and includes several instructions to enable a device (may be a single-chip microcomputer, a chip, etc.) or a processor to execute all or part of the steps of the methods described in the embodiments of the present disclosure. The aforementioned storage media include: U disk, mobile hard disk, read-only memory (ROM), random access memory (RAM), magnetic disks or optical disks and other media that may store program codes.

A person of ordinary skill in the art may understand that the above-mentioned embodiments are specific embodiments for realizing the present disclosure, and in actual applications, various changes may be made in form and details without departing from the spirit and scope of the present disclosure.

1. A method for scheduling an elevator, applied to a server, comprising:
determining an elevator schedule request, wherein the elevator schedule request comprises starting floor information and target floor information;
determining a target elevator to be scheduled to a target robot based on the elevator schedule request and operation information of schedulable elevators;
generating a control instruction based on the starting floor information, the target floor information, and identification information of the target elevator; and
sending the control instruction to an elevator control device, wherein the elevator control device controls movement of the target elevator.

2. The method for scheduling the elevator of claim 1, wherein before sending the control instruction to the elevator control device, the method further comprises:
receiving an elevator call request sent by the target robot, wherein the elevator call request comprises authorization information, and the authorization information is information fed back to the target robot by the elevator control device in response to receiving an authorization information request sent by the target robot; and
determining that the authorization information in the elevator call request is correct.

3. The method for scheduling the elevator of claim 1, wherein the target robot communicates with the elevator control device via a near field communication technology.

4. The method for scheduling the elevator of claim 1, wherein the elevator schedule request is sent by the target robot upon determining that an elevator is to be taken by itself.

5. The method for scheduling the elevator of claim 1, wherein after determining the target elevator to be scheduled to the target robot based on the elevator schedule request and the operation information of schedulable elevators, the method further comprises:
sending identification information of the target elevator to the target robot, wherein the identification information of the target elevator is used to identify the target elevator.

6. The method for scheduling the elevator of claim 1, wherein before determining the target elevator to be scheduled to the target robot based on the elevator schedule request and the operation information of schedulable elevators, the method further comprises:
determining the target robot for delivering goods based on robot information, wherein the robot information comprises state information of a robot and/or information of a floor where the robot is currently located; and
sending a delivery instruction to the target robot.

7. The method for scheduling the elevator of claim 6, wherein
determining the target robot based on the robot information comprises:
determining the target robot based on the robot information and order information of the goods;
before sending the delivery instruction to the target robot, the method further comprises:
generating the delivery instruction based on the order information of the goods.

8. The method for scheduling the elevator of claim 1, wherein the elevator schedule request further comprises authentication information of the target robot;
after determining the elevator schedule request, and before determining the target elevator to be scheduled to the target robot based on the elevator schedule request and the operation information of schedulable elevators, the method further comprises:
verifying the authentication information, and
determining that the authentication information is successful verified.

9. The method for scheduling the elevator of claim 1, wherein after sending the control instruction to the elevator control device, the method further comprises:
sending, after determining that the target elevator reaches a floor corresponding to the starting floor information, an elevator entry instruction to the target robot, wherein the elevator entry instruction is used to instruct the target robot to enter the target elevator;
sending, after determining that the target elevator reaches a floor corresponding to the target floor information, an elevator exit instruction to the target robot, wherein the elevator exit instruction is used to instruct the target robot to leave the target elevator.

10. The method for scheduling the elevator of claim 1, wherein the operation information of schedulable elevators comprises state information of schedulable elevators, and the state information of a schedulable elevator is used to indicate this schedulable elevator is in a scheduled state or an unscheduled state;
determining the target elevator to be scheduled to the target robot based on the elevator schedule request and the operation information of schedulable elevators comprises:
selecting, based on the state information of respective elevators, one elevator from elevators in the unscheduled state as the target elevator.

11. The method for scheduling the elevator of claim 1, wherein the operation information of a schedulable elevator comprises a moving direction of this schedulable elevator and current floor information of this schedulable elevator;
determining the target elevator to be scheduled to the target robot based on the elevator schedule request and the operation information of schedulable elevators comprises:
determining a moving direction of the target robot based on the starting floor information and the target floor information;
taking, based on the operation information of schedulable elevators, one or more elevators having a moving direction which is the same as the moving direction of the target robot as candidate schedule elevators; and
selecting, based on the current floor information of each of the candidate schedule elevators and the starting floor information, one elevator from the candidate schedule elevators as the target elevator.

12. The method for scheduling the elevator of claim 1, wherein the operation information of a schedulable elevator comprises an occupancy rate of this schedulable elevator;
determining the target elevator to be scheduled to the target robot based on the elevator schedule request and the operation information of schedulable elevators comprises:
selecting, based on the occupancy rate of schedulable elevators, a schedulable elevator of which the occupancy rate is the lowest as the target elevator.

13. The method for scheduling the elevator of claim 1, wherein the operation information of a schedulable elevator comprises stopping floors information of this schedulable elevator;
determining the target elevator to be scheduled to the target robot based on the elevator schedule request and the operation information of schedulable elevators comprises:
determining, based on the stopping floors information of schedulable elevators and the elevator schedule request, whether there is a schedulable elevator of which stopping floors comprise a floor corresponding to the starting floor information and/or a floor corresponding to the target floor information; and
taking, in response to determining that there is such a schedulable elevator of which the stopping floors comprise the floor corresponding to the starting floor information or the floor corresponding to the target floor information, this schedulable elevator as the target elevator.

14. The method for scheduling the elevator of claim 1, wherein the operation information of a schedulable elevator comprises a number of stopping floors of this schedulable elevator;
determining the target elevator to be scheduled to the target robot based on the elevator schedule request and the operation information of schedulable elevators comprises:
selecting, based on the number of stopping floors of schedulable elevators, a schedulable elevator of which the number of stopping floors is the smallest as the target elevator.

15. (canceled)

16. A server comprising:
at least one processor; and
a memory communicatively connected with the at least one processor; and
a communication component receiving and sending data under the control of the processor, wherein the communication component is communicatively connected with an elevator control device;
wherein the memory stores instructions executable by the at least one processor, and the instructions are executed by the at least one processor to implement: determining an elevator schedule request, wherein the elevator schedule request comprises starting floor information and target floor information; determining a target elevator to be scheduled to a target robot based on the elevator schedule request and operation information of schedulable elevators; generating a control instruction based on the starting floor information, the target floor information, and identification information of the target elevator; and sending the control instruction to the elevator control device, wherein the elevator control device controls movement of the target elevator.

17. The server of claim 16, wherein the processor is further configured to:
before sending the control instruction to the elevator control device, receive an elevator call request sent by the target robot, wherein the elevator call request comprises authorization information, and the authorization information is information fed back to the target robot by the elevator control device in response to receiving an authorization information request sent by the target robot; and
determine that the authorization information in the elevator call request is correct.

18. The server of claim 16, wherein the target robot communicates with the elevator control device via a near field communication technology.

19. The server of claim 16, wherein the elevator schedule request is sent by the target robot upon determining that an elevator is to be taken by itself.

20. The server of claim 16, wherein the processor is further configured to:
after determining the target elevator to be scheduled to the target robot based on the elevator schedule request and the operation information of schedulable elevators, send identification information of the target elevator to the target robot, wherein the identification information of the target elevator is used to identify the target elevator.

21.-29. (canceled)

30. A non-transitory computer-readable storage medium storing a computer program, wherein the computer program is executed by a processor to perform operations including:
determining an elevator schedule request, wherein the elevator schedule request comprises starting floor information and target floor information;
determining a target elevator to be scheduled to a target robot based on the elevator schedule request and operation information of schedulable elevators;
generating a control instruction based on the starting floor information, the target floor information, and identification information of the target elevator; and
sending the control instruction to an elevator control device, wherein the elevator control device controls movement of the target elevator.
